(19) United States
(12) Patent Application Publication
(10) Pub. No.: US 2007/0188616 A1
(43) Pub. Date: Aug. 16, 2007

(54) Camera recording system for water sports

(76) Inventor: Kevin Goodwin, Queen Creek, AZ (US)

Correspondence Address: GREENBERG & LIEBERMAN, LLC, 2141 WISCONSIN AVE, N.W., SUITE C-2, WASHINGTON, DC, 20007, US

(21) Appl. No.: 11/670,116

(22) Filed: Feb. 1, 2007

Related U.S. Application Data
(60) Provisional application No. 60/766,620, filed on Feb. 1, 2006.

(51) Int. Cl. H04N 5/225; B63B 21/56; H04N 9/04

(52) U.S. Cl. 348/207.99; 114/242

(57) ABSTRACT

A durable Closed Circuit Camera System for boats that follows any object towed behind the boat, such as a water-skier or wake boarder, while allowing the driver to both see and fully control the camera all as a protective exterior secures the DVR, keyboard and other items featured in the Closed Circuit Camera System from succumbing to the elements.

This Application is a Nonprovisional of Application Ser. No. 60/766,620, filed on Feb. 1, 2006.

### BACKGROUND OF THE INVENTION

1. Field of the Invention

The present invention relates primarily to a support apparatus, full and safe boat driver control apparatus in regard to the closed circuit video camera element, two connecting clamps, a turning stand, adaptable polypropylene protective enclosures, and three compartments allowing space for the installation of the electronic circuit board of the present invention to be installed and hard wired to the camera and to a 12 VDC power source supplied by the boats battery.

and the ability for the driver of the boat to be able to safely navigate the boat while viewing the skier for which they are responsible. And giving the driver the ability to control the camera while driving the boat.

2. Description of the Prior Art

It is desirable to record the movement of a towed object, such as a water skier, with a camcorder or a motion picture camera for both entertainment and subsequent review to improve the water skier's technique for competition. Water skiers move back and forth across the wake of the boat from which they are towed. Keeping a camera aimed at the water skier can be a problem because of rapid movement of the skier, boat movement affecting balance of the camera operator, and sometimes the only person available in the boat for operating the camera must also operate the boat. There is a need for a boat mounted camera support that automatically tracks a towed object such as a water skier, and for the driver to be able to view what is being recorded and control the recording while still driving the boat.

Power boats used to pull wake boarders are commonly equipped with a tower which provides an anchor point for attaching a two rope high above the floor of the boat. The tower is a vertical structure rising from both sides of the boat, then bending to meet at the center of the boat. It mounts to the deck and extends to a level so that attachment of a tow rope gives skier enhanced mobility.

The mount allowing the recording of the towed object has been around for several years however it has never allowed the driver of the boat to see the skier while facing forward or even to see any of the footage being recorded. Furthermore the driver had no control of what was being recorded without him, or another occupant of the boat physically pressing the start and stop button on the camera mounted to the tower or pylon. If you were to attach a portable video camera to a mount on the tower of a boat, you could not see the image being recorded or start and stop recording without climbing up on the seats to the top of the tower and controlling the camera. This is dangerous and against the law.

Most Wakeboarding boats now come with a rear view mirror to provide the driver with the ability to face forward and drive the boat safely, while keeping the ability to see the skier behind the boat. The mirror however does not provide a full 180 degree field of view from the back of the boat allowing the skier to leave the drivers view in the rear view mirror. This is complicated further if the driver chooses to sit in a bolstered chair by blocking the view of the skier, or any other occupants of the boat that may be an obstruction in the mirror. With the camera placed high above the floor of the boat on the tower it is not obstructed by the driver or any of the occupants of the boat and allows the camera to track the skier a full 180 degrees.

### SUMMARY OF THE INVENTION

The present invention provides a hard-wired camera that can track the skier behind the boat. Another object of the present invention is to provide a portable digital video recorder to allow the operator or skier to remove the saved images from the boat once filming is completed.

Two clamps fasten to the tower of a boat and holds a rod extending upwardly offset from the pylon. A turning stand is mounted for panning rotation above the rod. A guidance arm extends rigidly from the platform over the tow rope in an axial direction for attachment thereto at a location spaced from the pylon. The platform can pan in response to lateral movement of the tow rope. On the rotational platform a camera enclosure is mounted.

The camera enclosure is a polypropylene enclosure that houses a high resolution closed circuit video camera that has its power, video feed, and zoom contacts connected to a circuit board housed with thin the portable digital video recorder enclosure. The purpose of the enclosure is to protect the camera from sun, wind and rain among other elements.

Above the windshield of the boat there is an arm that is attached to the tower. This extends out from the right side of the tower directly within the drivers line of sight. Another enclosure made of polypropylene is mounted to this arm in such a manner as to allow the driver to turn or rotate the enclosure to best accommodate the driver, as they would adjust a rear view mirror. Within this DVR Enclosure are three compartments allowing space for the installation of an electronic circuit board to be installed and hard wired to the camera and to a 12 VDC power source supplied by the boats battery. The second compartment is vented to the front of the boat to allow air flow into the enclosure and within it is mounted a blower to assist in air circulation to prevent the digital video recorder from overheating. The third compartment is in front of the other two compartments and is covered on all sides with durable compression foam that absorbs the vibration caused by the boat.

The DVR is the connected to the Circuit board to supply power and the feed from the video camera. There is a 7″ diagonally cut whole in the front cover of the enclosure surrounded by a foam gasket allowing the operator to insert the DVR and close the cover, to create a seal from the water but yet allow the operator to view the screen on the front of the DVR. On the dashboard a sealed membrane keypad is mounted near the throttle of the boat. This keypad is then connected to the circuit board within the DVR enclosure allowing the driver to zoom in and out on the camera as well as stop and start recording by simply pressing the buttons on the keypad.

A further object of the present invention is to provide a method to allow the driver of the boat to control the camera while safely driving the boat.

A further object of the present invention is to place the image collected from the camera that is tracking the skier, within the line of sight of the driver of the boat so as to allow the driver to see the skier without having to look over their shoulders.

The present invention includes the ability to automatically track a towed object, such as a water skier, with a camera support that can pan in response to lateral movement of a tow rope. Furthermore it allows the driver of the boat to view the image of the skier allowing the driver to keep their eyes in the direction that they are driving while seeing what the skier is doing behind them.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWING

FIG. 1 is a front view of the present invention showing the DVR enclosure with the cover and divider two removed.

FIG. 2 is a front view of the present invention showing the DVR enclosure with the cover removed.

FIG. 3 is a front view of the present invention showing the DVR enclosure with the front cover in place.

FIG. 4 is a view of the present invention as seen when installed on a boat from the rear of the boat.

FIG. 5 is a view of the present invention as seen when installed on a boat from the side of the boat.

FIG. 6 is a schematic diagram of the camera enclosure of the present invention.

FIG. 7 is a schematic diagram of the DVR enclosure of the present invention.

### DESCRIPTION OF THE PREFERRED EMBODIMENT

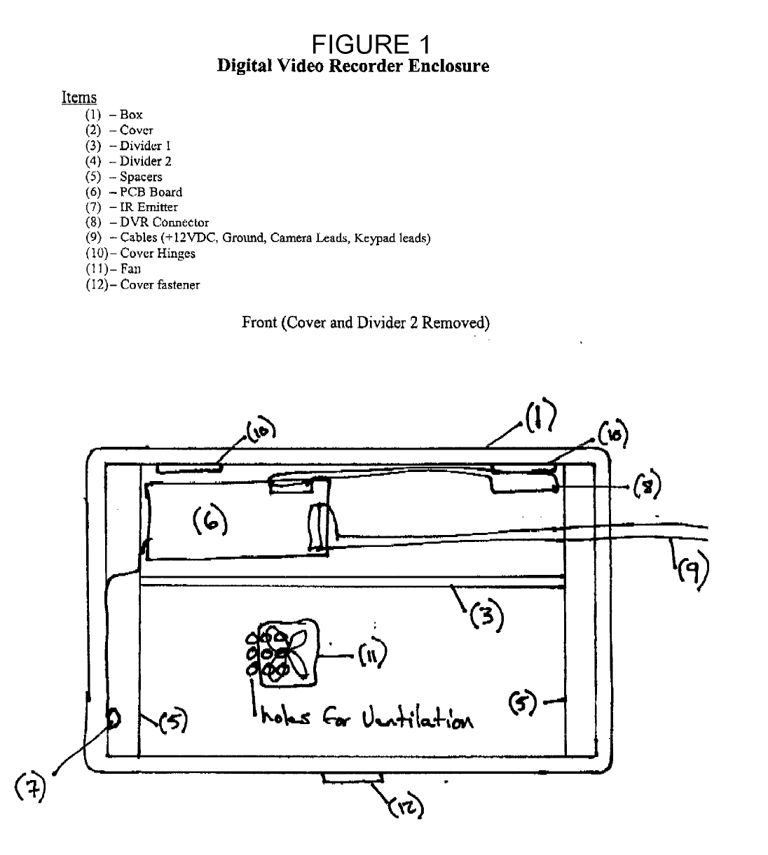

Looking now at FIG. 1, Digital Video Recorder Enclosure, is shown with the front removed allowing you to see where the components of the enclosure will be located. The first compartment at the top of the enclosure will house all electronic components and contain all connections from other elements of the system. The Circuit Board (6) has been designed to take a 12 VDC source and provide a 12 VDC source to the camera and the blower motor, and a 6 VDC power to the DVR. It also takes the signals from the keypad and emits IR signals to control the DVR and power signals to control the zoom rate of the camera. The connector for the DVR (8) is found here and the connection from the battery and the camera (9). The depth of these compartments is only 1″ and it is separated from the second compartment by a ¼″ thick piece of Polypropylene (3) allowing the electronics to stay protected from water while allowing the second compartment to have ventilation holes and a blower (11) to keep the DVR cool.

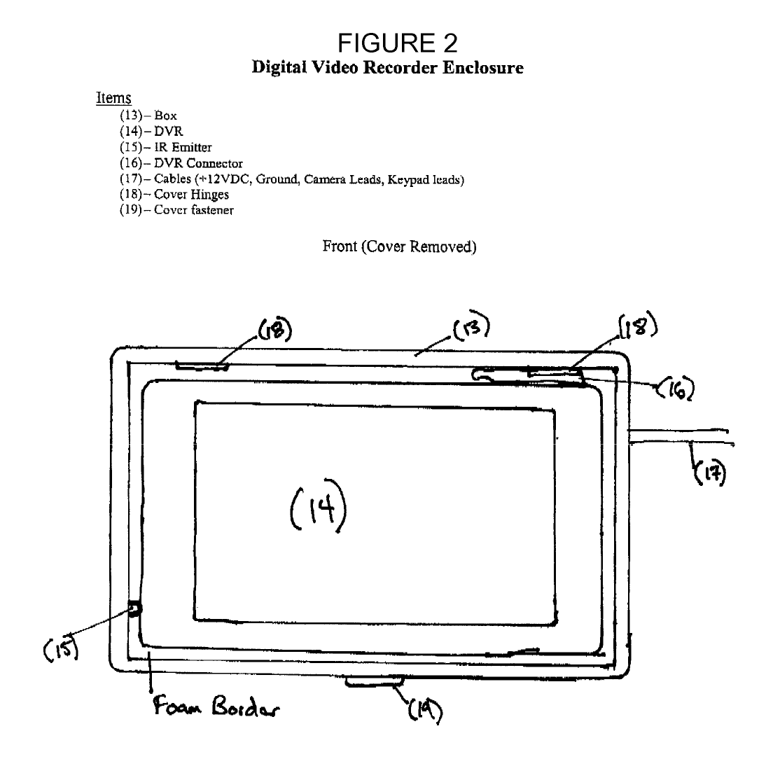

With reference to FIG. 2, we have taken the enclosure and inserted a ¼″ piece of polypropylene to make the third compartment where the foam is inserted protecting the DVR (14) from vibration.

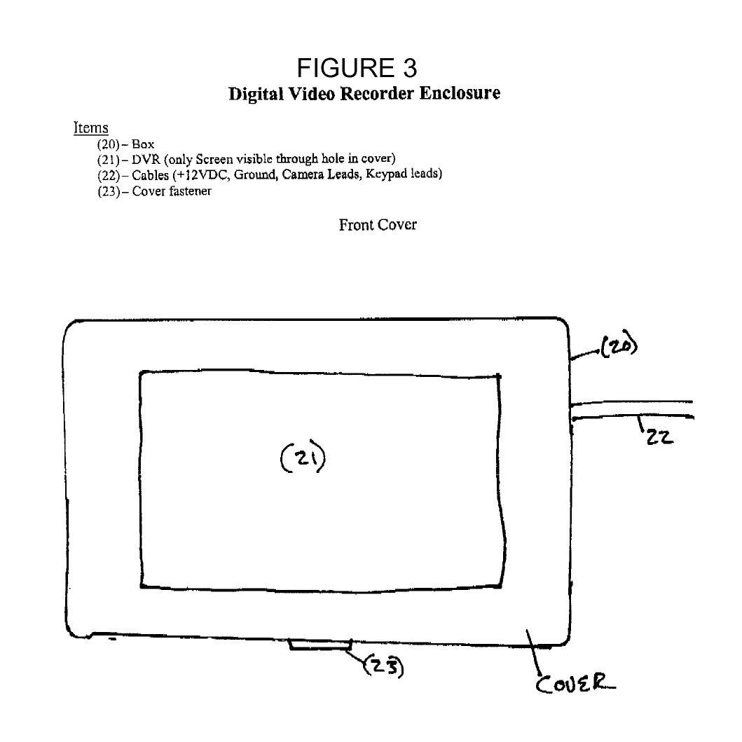

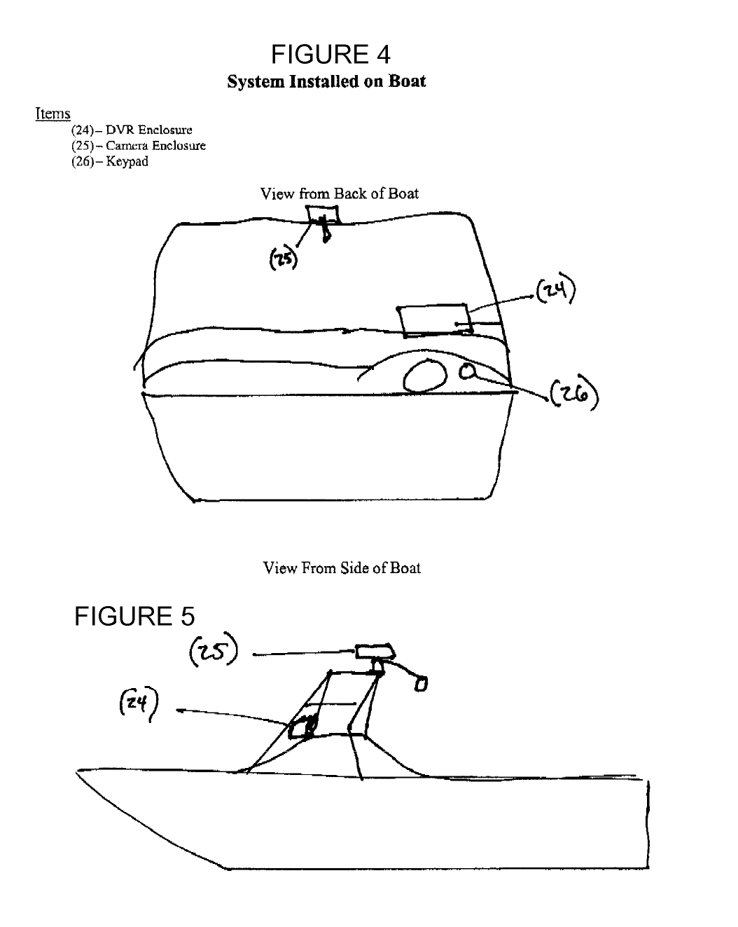

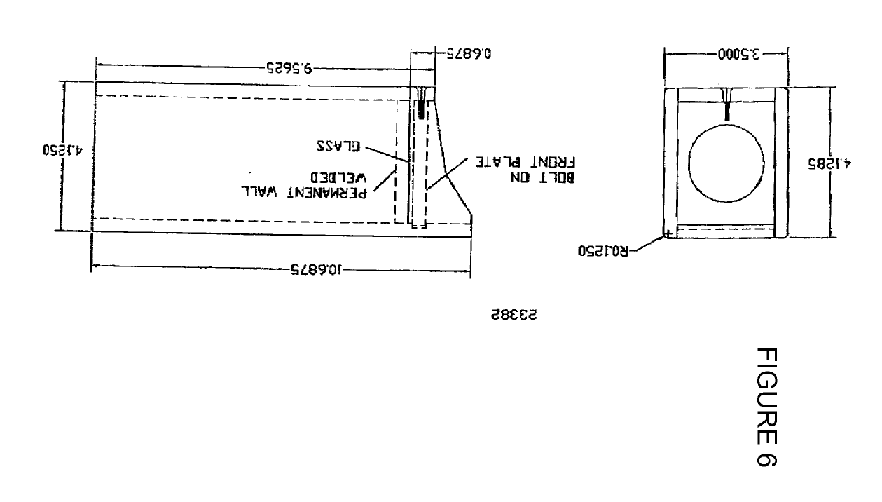

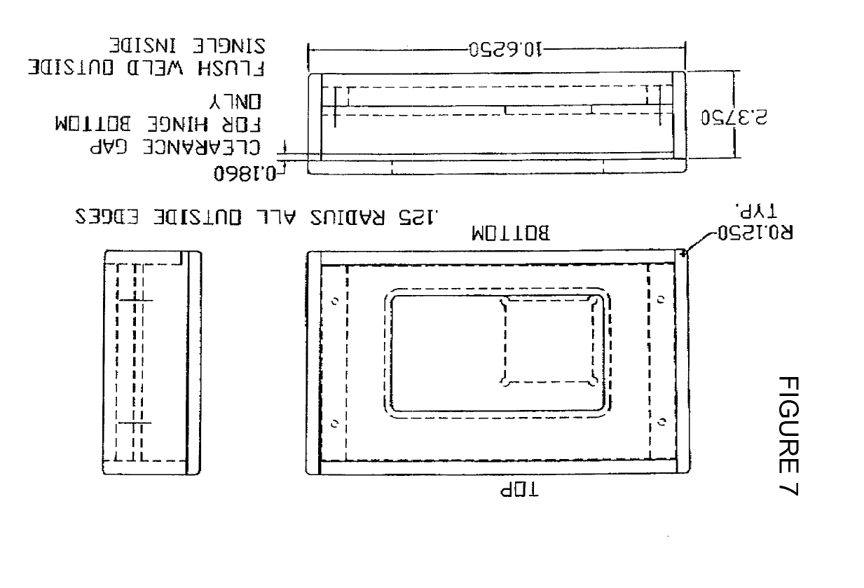

As shown in FIG. 3, the cover to the enclosure has now been attached leaving only the screen of the DVR exposed to the drivers view and securing the DVR. As shown in FIG. 4, the view of the boat as if you were standing at the back of the boat allows you to see the 3 primary elements of the camera system. First at the top of the boat mounted on the tower is the Camera (25) the wiring from the camera is then pulled through the inside of the tubing that the tower is constructed from. It goes to the DVR enclosure (24) pictured just above the windshield and directly within the drivers line of sight. The final item is the keypad (26) mounted near the steering wheel of the boat within the reach of the driver.

Although the present invention has been described in terms of the presently preferred embodiment, it is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

I claim:

1. A system for a boat driver, comprising:
a camera configured to track a skier;
an image viewable by the boat driver, received from said camera; and
wherein said driver can control said camera and begin and end a recording via said camera.
